(19) United States
(12) Patent Application Publication
(10) Pub. No.: US 2022/0223129 A1
(43) Pub. Date: Jul. 14, 2022

(54) AUDIO PROCESSING METHOD, APPARATUS, AND SYSTEM

(71) Applicant: GuangZhou LAVA MUSIC LLC., Guangdong (CN)

(72) Inventors: ZI-TIAN LU, Guangzhou (CN); Cheuk Ho TSE, Guangzhou (CN); SHUAI YIN, Guangzhou (CN); KAI-SHENG SU, Guangzhou (CN); FANG-FANG CHEN, Guangzhou (CN)

(21) Appl. No.: 17/614,494

(22) PCT Filed: Jun. 8, 2020
(86) PCT No.: PCT/CN2020/094955

§ 371 Date: Nov. 26, 2021

(30) Foreign Application Priority Data
Jun. 6, 2019 (CN) 201910495977.8

(51) Int. Cl. G10H 3/18

(52) U.S. Cl. CPC G10H 3/186; G10H 2210/056; G10H 2210/265; G10H 3/183

(57) ABSTRACT

An audio processing method, apparatus, and system. The processing method is applied to a sound pickup, and the sound pickup is connected to a controller. The method comprises: receiving timbre instruction information sent by a controller (S101); and analyzing the timbre instruction information, and carrying out, according to the timbre instruction information, timbre processing on audio that is picked up, wherein the timbre instruction information comprises timbre addition instruction information and/or timbre change instruction information (S102). The selection of various timbres in an audio processing process is enabled, the requirement for the integration of the related functions is met, and user experience is improved.

### FIELD

The subject matter herein relates to audio processing method, apparatus, and system.

### BACKGROUND

Existed guitar pickups are mainly used for timbre adjustment and tuning functions. For selections with a wide variety of timbres, existing guitar pickups require external effects, and other devices that require the use of musical beats, recording, and other playing-related functions, the integration of related functions is difficult to achieve.

### SUMMARY

The present disclosure discloses an audio processing method, apparatus, and system, which solves the problem of the inability to select multiple timbres caused by the separation of the pickup and the effector in the prior art, thereby multiple timbres can be selected in the audio processing process, the integration needs of related functions are met, and the user experience is improved.

In a first aspect, embodiments of the present disclosure disclose an audio processing method, applied in a pickup, the pickup is connected to a controller, the audio processing method includes:

receiving a timbre instruction information sent by the controller;

analyzing the timbre instruction information, and performing timbre processing on a gathered audio according to the timbre instruction information, wherein, the timbre instruction information includes a timbre adding instruction information and/or a timbre modifying instruction information.

The embodiments of the present disclosure provide a first possible implementation manner of the first aspect, wherein, the gathered audio is a real-time audio, the step of performing timbre processing on the gathered audio according to the timbre instruction information includes:

performing processing of adding timbre and/or modifying timbre to the real-time audio through a timbre processing chip;

sending the real-time audio after adding timbre and/or changing timbre processing to a speaker, the speaker outputting the modified real-time audio.

The embodiments of the present disclosure provide a second possible implementation manner of the first aspect, wherein gathered audio is a pre-stored original audio, the step of receiving the timbre instruction information sent by the controller includes:

receiving a command packet sent by the controller, wherein, the command packet comprises the timbre instruction information and the pre-stored original audio;

analyzing the command packet, to obtain the timbre instruction information and the pre-stored original audio in the command packet.

The embodiments of the present disclosure provide a third possible implementation manner of the first aspect, wherein, the step of performing timbre processing on the gathered audio according to the timbre instruction information includes:

preforming timbre processing on the pre-stored original audio according to the timbre instruction information through a timbre processing chip; the timbre processing process comprises adding timbre and/or modifying timbre;

the pre-stored original audio after timbre processing is sent to a speaker, the speaker outputting the modified pre-stored original audio.

The embodiments of the present disclosure provide a fourth possible implementation manner of the first aspect, wherein, if the gathered audio is the real-time audio, the audio processing method further includes:

recording the real-time audio;

sending the real-time audio to the controller, the real-time audio is backed up by the controller.

For example, the gathered audio is the real-time audio, the step of performing timbre processing on the gathered audio according to the timbre instruction information includes:

preforming processing of modifying timbre of the real-time audio through a timbre processing chip;

sending the real-time audio after timbre processing to a speaker, the speaker outputting the modified real-time audio.

For example, the gathered audio is an audio carrying sound effects; the step of receiving a timbre instruction information sent by the controller includes:

receiving a command pack sent by the controller, wherein, the command packet comprises the timbre instruction information and the audio carrying sound effects;

the step of analyzing the timbre instruction information includes:

analyzing the command packet, to obtain the timbre instruction information and the audio carrying sound effects carried in the command packet.

For example, the step of performing timbre processing on the gathered audio according to the timbre instruction information includes:

preforming processing of modifying sound effect to the audio carrying sound effects through a timbre processing chip;

sending the audio with modified sound effects to a speaker, the speaker outputting the audio with modified sound effects.

For example, the gathered audio is a real-time audio carrying sound effects; step of performing timbre processing on the gathered audio according to the timbre instruction information includes:

preforming processing of modifying sound effect to the audio carrying sound effects through a timbre processing chip;

sending the audio with modified sound effects to a speaker, the speaker outputting the audio with modified sound effects.

In a second aspect, embodiments of the present disclosure further provides an audio processing method, applied in a controller, the controller is connected to a sound pickup, the audio processing method includes:

generating a timbre instruction information when a user is detected to trigger a timbre function, wherein the timbre instruction information comprises a timbre adding instruction information and/or a timbre modifying instruction information;

sending the timbre instruction information to the pickup, the pickup performs timbre processing on a gathered audio according to the timbre instruction information.

The embodiments of the present disclosure provide a first possible implementation manner of the second aspect, wherein the method further comprises:

receiving a real-time audio gathered by the pickup, storing the real-time audio as a back up.

In a third aspect, embodiments of the present disclosure disclose an audio processing apparatus, applied in a pickup, the pickup is connected to a controller, the audio processing apparatus includes:

a receiving module, configured to receive a timbre instruction information sent by the controller;

a processing module, configured to analyze the timbre instruction information, and perform timbre processing on gathered audio according to the timbre instruction information, wherein the timbre instruction information comprises the timbre adding instruction information and/or the timbre modifying instruction information.

In a fourth aspect, embodiments of the present disclosure disclose an audio processing apparatus, applied in a controller, the controller is connected to a pickup, the audio processing apparatus includes:

a generating module, configured to generate a timbre instruction information if a user is detected to trigger a timbre function, wherein, the timbre instruction information comprises a timbre adding instruction information and/or timbre modifying instruction information;

a sending module, configured to send the timbre instruction information to the pickup, the pickup performing timbre processing on the gathered audio according to the timbre instruction information

In a fifth aspect, embodiments of the present disclosure disclose an audio processing system, the system comprising a pickup, a controller, and a server; the controller is connected to the pickup and the server;

wherein, the pickup is provided with the audio processing apparatus of the third aspect; the controller is provided with the audio processing apparatus of the fourth aspect.

Other features and advantages of the present disclosure will be described in the detailed description, and as obvious from the description, or understood by implementing the present disclosure. The purpose and other advantages of the present disclosure are realized and obtained by the structures specifically pointed out in the description and the drawings.

The embodiments of this disclosure are described with reference to the accompanying drawings.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a flowchart of an audio processing method in an embodiment of the present disclosure.

FIG. 2 is a flowchart of an audio processing method in another embodiment of the present disclosure.

FIG. 3 is a diagram of an audio processing apparatus in an embodiment of the present disclosure.

FIG. 4 is a diagram of an audio processing apparatus in another embodiment of the present disclosure.

FIG. 5 is a diagram of an audio processing system in an embodiment of the present disclosure.

### DESCRIPTION OF MAIN COMPONENTS OR ELEMENTS

Receiving module 10;
processing module 20;
generating module 30;
sending module 40.

### DETAILED DESCRIPTION

In order to make the objectives, technical solutions, and advantages of the embodiments of the present disclosure clearer, the technical solutions of the present disclosure will be described with reference to the accompanying drawings. The described embodiments are part of embodiments of the present disclosure, but not all of the embodiments. Based on the embodiments in the present disclosure, all other embodiments obtained by those of ordinary skill in the art without creative work shall fall within the protection scope of the present disclosure.

The following embodiment are disclosed in detail.

### First Embodiment

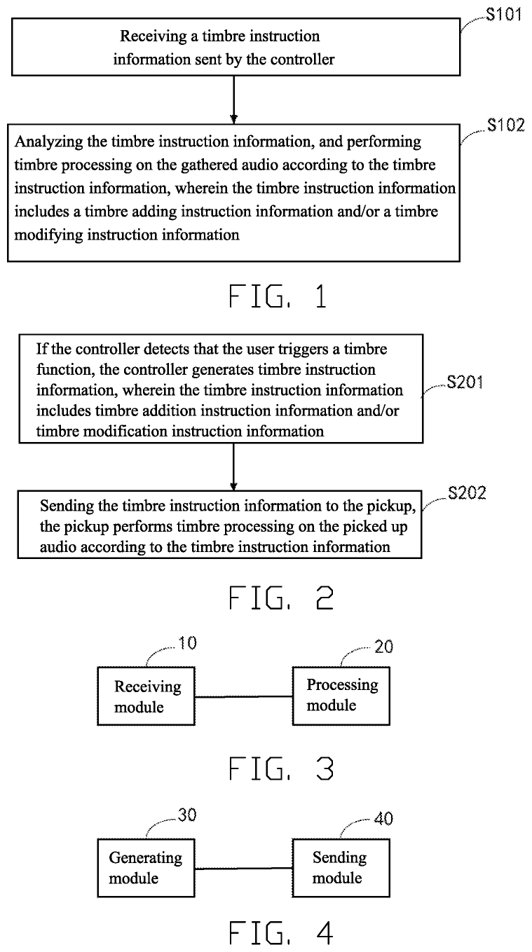

An audio processing method is disclosed in the first embodiment. The audio processing method is suitable for use in scenarios where a user selects a timbre before playing, or adds a timbre or changes a timbre after playing. The audio processing method allows the selection of multiple timbres in the audio processing process. For example, the governing body of the method is a pickup for gathering sound. The pickup is connected to a controller. Any pickup that can gather sound and receive and execute instruction sent by the controller falls within the scope of the description of the embodiments of the present disclosure. FIG. 1 is a flowchart of the audio processing method in the first embodiment of the present disclosure. Referring to FIG. 1, the method includes the following steps:

Step S101, receiving a timbre instruction information sent by the controller;

For example, the controller includes a data processing unit. When the controller detects a user triggering a timbre function, the data processing unit generates a timbre instruction information according to a timbre function operation of the user. The timbre function operation includes but is not limited to addition or modification of timbre, and audio trimming. For ease of understanding, the embodiments of the present disclosure take the addition or modification of timbre as a described example. When the controller detects the user triggering timbre function operation, the data processing unit generates timbre instruction information and sends the timbre instruction information to the pickup.

Step S102, analyzing the timbre instruction information, and performing timbre processing on the gathered audio according to the timbre instruction information, wherein the timbre instruction information includes a timbre adding instruction information and/or a timbre modifying instruction information.

For example, the timbre instruction information includes a timbre adding instruction information and/or a timbre modifying instruction information. After the pickup receives the timbre instruction information sent by the controller, the pickup parses the timbre instruction information to obtain parameter information of the timbre instruction information. The timbre instruction information of different functions has different parameter information. Then, a timbre processing chip in the pickup performs timbre processing on the gathered audio according to different parameter information. Wherein, the timbre processing chip is provided with a processing algorithm. The processing algorithm processes the parameter information. If the audio gathered by the pickup is real-time audio, the timbre processing chip in the pickup performs processing by adding timbre to and/or modifying timbre of the real-time audio, and the real-time audio after timbre processing is sent to a speaker. The speaker outputs the modified real-time audio.

Additionally, the pickup can record the real-time audio, and send the real-time audio to the controller. The controller may back up the real-time audio. Wherein, the controller includes a data storage unit. The data storage unit may provide storage place and storage space for data that needs to be stored. Therefore, after the controller receives the real-time audio, the real-time audio can be backed up and stored in the data storage unit, the user can process the real-time audio after storage.

If the audio picked up by the pickup is a pre-stored original audio, at this time, the pickup receives a command packet sent by the controller. The command packet includes the timbre instruction information and the original audio. When the pickup receives the command packet, the pickup analyzes the command packet to obtain the timbre instruction information and the pre-stored original audio, and the pickup performs timbre processing on the pre-stored original audio according to the timbre instruction information through the timbre processing chip. The timbre processing process includes adding timbre and/or modifying timbre. The pre-stored original audio after timbre processing is sent to the speaker, the speaker outputs the modified pre-stored original audio.

Additionally, if the audio picked up by the pickup is an audio already carrying sound effects, the sound effects of the audio can be modified, and the audio carrying sound effects does not need to be overwritten with an original audio. The sound effects of the audio can be modified directly. That is, a modifiable timbre part of the audio carrying sound effects may be replaced directly. The modified audio carrying sound effects is sent to the speaker, and the speaker outputs the modified audio carrying sound effects. Various timbres in the audio processing process can be selected, and various needs of customers are met.

For example, the audio carrying sound effects may be an audio stored in the data storage unit, or a real-time audio carrying sound effects, not being limited in the embodiment of the present disclosure.

For example, audio after timbre processing can also be stored, that is, the real-time audio after adding timbre processing and/or modifying timbre processing, the original audio after timbre processing, and the modified audio carrying sound effects can all be stored.

For example, through storing the original audio, the original audio can be retrieved in a process of modifying sound effects, to obtain audio with different timbre processing.

Furthermore, the pickup may also send collected data to the controller. The data can include user's playing activities and related information. As long as it is generated according to and within the performance, all the information required as to the performance is included in the description of the data. For example, the data may include selection of a function triggered by a demand to play, the real-time audio generated by user's playing, the audio after the secondary processing of the original audio, the result of the audio analysis and determinations, and the time and place of the playing, etc. When the controller receives the data, the data is stored in the data storage unit. Additionally, the controller also includes a data analysis unit and a data display unit. The data analysis unit analyzes the received data to obtain an analyzed audio status, and the analyzed audio status is displayed by the data display unit. The user may monitor the audio processing effect.

Additionally, the audio may also be synthesized by superimposing multiple audio tracks, in the embodiment of the present disclosure. Synthesized audio may include a media accompaniment sound, a guitar sound, and a guitar sound with effect. The media accompaniment sound is retrieved from the data storage unit of the controller. The guitar sound is the audio picked up by the pickup from a guitar string. The guitar sound with effect is obtained by processing the picked-up guitar sound by the timbre processing chip in the pickup according to the processing algorithm and the timbre instruction information sent by the controller. The guitar sound with effect is sent to the controller for storage. The controller stores the received guitar sound with effect in the data storage unit, and generates playback instruction information. The playback instruction information is sent to the pickup from the controller, and the pickup outputs audio according to the playback instruction information. At this time, an audio output form is the synthesized audio of at least two of the media accompaniment sound, the guitar sound, and the guitar sound with sound effects. The superposition of multiple timbres of audio can be achieved, the needs of customers for multiple timbres are met.

### Second Embodiment

FIG. 2 is a flowchart of an audio processing method in the second embodiment of the present disclosure.

Referring to FIG. 2, the governing body of the method is the controller. The method includes following steps:

Step S201, if the controller detects that the user triggers a timbre function, the controller generates timbre instruction information, wherein the timbre instruction information includes timbre addition instruction information and/or timbre modification instruction information;

Step S202: the controller sends the timbre instruction information to the pickup, the pickup performs timbre processing on the picked up audio according to the timbre instruction information.

For example, if the controller detects the user triggering a function, the data processing unit in the controller generates the timbre instruction information and sends the timbre instruction information to the pickup. The pickup performs timbre processing on the gathered audio according to the timbre instruction information. Additionally, the controller also receives the real-time audio sent by the pickup, and stores the real-time audio in the data storage unit as a back up, which is convenient for the user to later process the real-time audio.

Furthermore, the controller further includes an instruction interaction unit and a data payment unit. The instruction interaction unit is used to select a function in the controller through an interaction by gesture or otherwise as defined by the user, so that the controller generates an instruction. Additionally, when the controller executes a paid item, such as executes a payment for streamed/downloaded music, the data payment unit is used to pay for the paid item, so that the user can use the paid item, thereby satisfying various needs of the customer.

### Third Embodiment

FIG. 3 is a diagram of an audio processing apparatus in the third embodiment of the present disclosure.

Referring to FIG. 3, the active body is a pickup, and the pickup is connected to a controller. The audio processing apparatus includes:

A receiving module 10, the receiving module 10 is used to receive timbre instruction information sent by the controller;

A processing module 20, the processing module 20 is used to analyze the timbre instruction information, and perform timbre processing on the picked up audio according to the timbre instruction information, wherein the timbre instruction information includes the timbre adding instruction information and/or the timbre modifying instruction information.

### Fourth Embodiment

FIG. 4 is a diagram of an audio processing apparatus in the fourth embodiment of the present disclosure.

Referring to FIG. 4, the governing body is a controller, and the audio processing apparatus includes:

A generating module 30, the generating module 30 is configured to generate the timbre instruction information if the user is detected to trigger the timbre function, where the timbre instruction information includes the timbre adding instruction information and/or timbre modifying instruction information;

A sending module 40, the sending module 40 is used to send the timbre instruction information to the pickup, the pickup performs timbre processing on the gathered audio according to the timbre instruction information.

### Fifth Embodiment

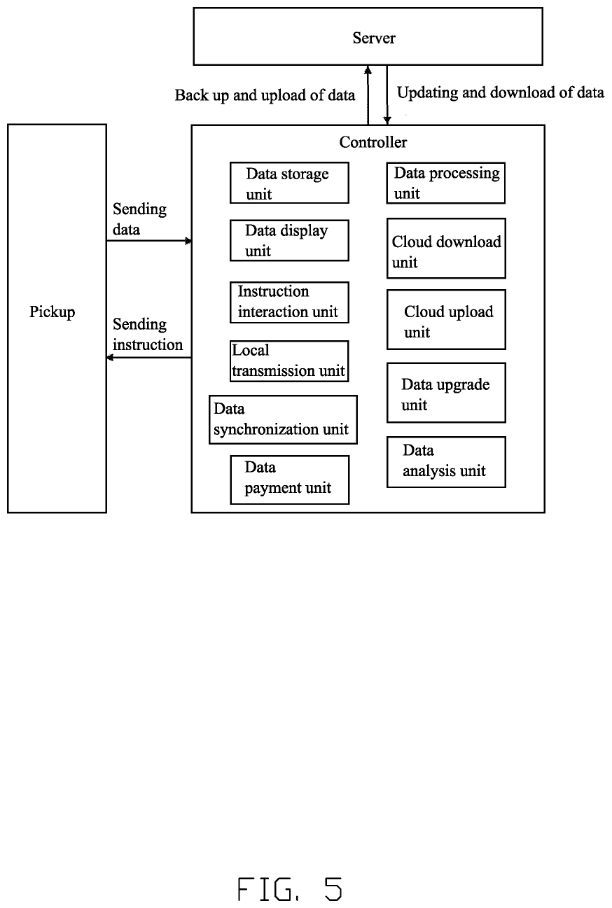

The embodiment of the present disclosure also provides a schematic diagram of an audio processing system. As shown in FIG. 5, the system includes the pickup, the controller, and a server. The controller is connected to the pickup and the server. The pickup is provided with the audio processing apparatus shown in FIG. 3. The controller is provided with the audio processing apparatus shown in FIG. 4.

For example, the system is an integrated system developed based on the Android platform, or the system may use the UCOS (Micro-Controller Operating System) series operating system to control the pickup, and use the Linux operating system and the QT, and system-less operating applications to instead the Android platform. The system and software applications are displayed by the controller. The controller may be an electronic device that can be interactively operated and can display information, and achieve audio processing by controlling the pickup. Additionally, the system is suitable for scenarios including but not limited to guitar playing, and can assist guitar playing activities. The audio processing system includes but not limited to metronome works, tuner, recorder, smart trainer and effector, etc., so as to satisfy user desiring various timbre, and the user's experience is improved.

Additionally, the controller also includes a cloud upload unit, a cloud download unit, a data upgrade unit, a data synchronization unit, and a local transmission unit. When the controller is connected to the Internet, the cloud upload unit sends data to the server through the server interface. After receiving the data, the server saves the data, the cloud download unit may download the data from the server through the server interface. Additionally, when the controller detects that the data saved in the server is updated, the controller may update the data in the controller through the data synchronization unit. When the controller detects that the server's data is updated in the system and software applications, the system and software on the controller can also be updated through the data upgrade unit, so as to better meet the needs of customers in the audio processing process. Additionally, the local transmission unit is also used to send data of external device to the controller through the type C interface on the guitar. The external device's data includes system and software application updates and audio data import, or export of data from the controller, including but not limited to the export of audio data, so as to play sound in various ways.

The present disclosure discloses an audio processing method, apparatus, and system. The method is applied to the pickup, the pickup is connected to the controller. The audio processing method includes: receiving timbre instruction information sent by the controller, analyzing the timbre instruction information, and performing timbre processing on the picked up audio according to the timbre instruction information. Wherein the timbre instruction information includes the timbre adding instruction information and/or the timbre modifying instruction information, avoiding the problem in the prior art of the pickup and the effector being separated, and thus not being able to select multiple timbres. In the present disclosure, multiple timbre selections can be selected and applied in the audio processing process, which helps to meet the integration requirements of related functions and improves the user experience.

The present disclosure also discloses an electronic device, the electronic device includes a memory, a processor, and a computer program stored in the memory. The computer program is capable of running on the processor. The processor executes the computer program to implement the steps of the audio processing method disclosed in the foregoing embodiments.

The present disclosure also discloses a computer-readable storage medium, and a computer program is stored on the computer-readable storage medium, and the steps of the audio processing method of the foregoing embodiment are executed when the computer program is run by a processor.

The computer program product disclosed in the embodiment of the present disclosure includes a computer-readable storage medium storing the program code. Instructions included in the program code can be used to execute the audio processing methods described in the foregoing method embodiments. The audio processing method will not be repeated here.

The working process of the system and device described above refers to the process in the embodiments of the foregoing method and will not be repeated here.

Additionally, in the description of the embodiments of the present disclosure, unless otherwise clearly specified and limited, the terms “installed”, “connected”, and “connected” should be understood in a broad sense. For example, the “installed”, “connected”, and “connected” may be fixed connections or detachable connections, or connected in one piece; may be a mechanical connection or an electrical connection; may be directly connected or indirectly connected through an intermediate medium, and may be the internal communication between two components. For those of ordinary skill in the art, the specific meanings of the above-mentioned terms in the present disclosure can be understood in specific situations.

If the function is implemented in the form of a software functional unit and sold or used as an independent product, it can be stored in a non-volatile computer readable storage medium executable by a processor. Based on this understanding, the technical solution of the present disclosure essentially or the part that contributes to the prior art or the part of the technical solution can be embodied in the form of a software product, and the computer software product is stored in a storage medium, including several instructions are used to make a computer device (which may be a personal computer, a server, or a network device, etc.) execute all or part of the steps of the methods described in the various embodiments of the present disclosure. The storage medium can include: U disk, mobile hard disk, read-only memory (ROM), random access memory (RAM), magnetic disks or optical disks and other media that can store program codes.

In the description of the present disclosure, it should be noted that the terms “center”, “upper”, “lower”, “left”, “right”, “vertical”, “horizontal”, “inner”, “outer”, etc. of indicating orientation or positional relationship is based on the orientation or positional relationship shown in the drawings, and is only for the convenience of describing the present disclosure and simplifying the description, and does not indicate or imply that the pointed device or element must have a specific orientation or a specific orientation. The structure and operation cannot therefore be construed as a limitation of the present disclosure. Additionally, the terms “first”, “second”, and “third” are only used for descriptive purposes, and cannot be understood as indicating or implying relative importance.

Finally, it should be noted that the above-mentioned embodiments are only specific implementations of the present disclosure, which are used to illustrate the technical solutions of the present disclosure, but not to limit it. The protection scope of the present disclosure is not limited. Although embodiments of the present disclosure are described in detail, those of ordinary skill in the art can still modify the technical solutions described in the embodiments disclosed in the present disclosure within the technical scope, or it can be easily conceived of changes, or equivalent replacements of some of the technical features; and these modifications, changes or replacements do not cause the essence of the corresponding technical solutions to deviate from the spirit and scope of the technical solutions of the embodiments of the present disclosure. Therefore, the protection scope of the present disclosure should be subject only to the claims.

The following points need to be explained:

(1) The drawings of the embodiments of the present disclosure only refer to the structures related to the embodiments of the present disclosure, and other structures can refer to the usual design.

(2) For clarity, in the drawings used to describe the embodiments of the present disclosure, the thicknesses of layers or regions are enlarged or reduced, that is, these drawings are not drawn according to actual scale. It should be noted that when an element such as a layer, film, region, or substrate is referred to as being “on” or “under” another element, the element can be “directly” on or “under” the other element, or there may be intermediate elements.

(3) In the case of no conflict, the embodiments of the present disclosure and the features in the embodiments can be combined with each other to obtain new embodiments.

The present application claims the priority of a Chinese patent application No. 201910495977.8, filed on Jun. 6, 2019, and the content of the Chinese patent application is quoted here in full as a part of this application.

1. An audio processing method, applied in a pickup, the pickup is connected to a controller, the audio processing method comprising:
receiving a timbre instruction information sent by the controller;
analyzing the timbre instruction information, and performing timbre processing on a gathered audio according to the timbre instruction information, wherein, the timbre instruction information includes a timbre adding instruction information and/or a timbre modifying instruction information.

2. The audio processing method of claim 1, wherein the gathered audio is a real-time audio, the step of performing timbre processing on the gathered audio according to the timbre instruction information comprises:
performing processing of adding timbre and/or modifying timbre to the real-time audio through a timbre processing chip;
sending the real-time audio after adding timbre processing and/or change timbre processing to a speaker, the speaker outputs the modified real-time audio.

3. The audio processing method of claim 1, wherein gathered audio is a pre-stored original audio, the step of receiving the timbre instruction information sent by the controller comprises:
receiving a command packet sent by the controller, wherein, the command packet comprises the timbre instruction information and the pre-stored original audio;
analyzing the timbre instruction information comprises:
analyzing the command packet, to obtain the timbre instruction information and the pre-stored original audio in the command packet.

4. The audio processing method of claim 3, wherein the step of performing timbre processing on the gathered audio according to the timbre instruction information comprises:
preforming timbre processing on the pre-stored original audio according to the timbre instruction information through a timbre processing chip; the timbre processing process comprises adding timbre and/or modifying timbre;
the pre-stored original audio after timbre processing is sent to a speaker, the speaker outputs the modified pre-stored original audio.

5. The audio processing method of claim 2, wherein if the gathered audio is the real-time audio, the audio processing method further comprises:
recording the real-time audio;
sending the real-time audio to the controller, the real-time audio is backed up by the controller.

6. The audio processing method of claim 1, wherein the step of performing timbre processing on the gathered audio according to the timbre instruction information comprises:
preforming processing of modifying timbre to the real-time audio through a timbre processing chip;
sending the real-time audio after timbre processing to a speaker, the speaker outputs the modified real-time audio.

7. The audio processing method of claim 1, wherein the piked-up audio is an audio carrying sound effects; the step of receiving a timbre instruction information sent by the controller comprises:
receiving a command pack sent by the controller, wherein, the command pack comprises the timbre instruction information and the audio carrying sound effects;
analyzing the command pack, to obtain the timbre instruction information and the audio carrying sound effects carried in the command pack.

8. The audio processing method of claim 7, wherein the step of performing timbre processing on the gathered audio according to the timbre instruction information comprises;
preforming processing of modifying sound effect to the audio carrying sound effects through a timbre processing chip;
sending the audio with modified sound effects to a speaker, the speaker outputs the audio with modified sound effects.

9. The audio processing method of claim 1, wherein the gathered audio is a real-time audio carrying sound effects; step of performing timbre processing on the gathered audio according to the timbre instruction information comprises:
preforming processing of modifying sound effect to the audio carrying sound effects through a timbre processing chip;
sending the audio with modified sound effects to a speaker, the speaker outputs the audio with modified sound effects.

10. An audio processing method, applied in a controller, the controller is connected to a pickup, the audio processing method comprising:
generating a timbre instruction information when a user is detected to trigger a timbre function, wherein the timbre instruction information comprises a timbre adding instruction information and/or a timbre modifying instruction information;
sending the timbre instruction information to the pickup, the pickup performs timbre processing on a gathered audio according to the timbre instruction information.

11. The audio processing method of claim 10, wherein the method further comprises:
receiving a real-time audio sent by the pickup, storing the real-time audio to back up the real-time audio.

12. An audio processing apparatus, applied in a pickup or a controller, the pickup is connected to the controller, the audio processing apparatus comprising:
a storage device, configured to store one or more programs; and
at least one processor, wherein the one or more programs, when executed by the at least one processor, cause the at least one processor to:
receive a timbre instruction information sent by the controller;
analyze the timbre instruction information, and perform timbre processing on a gathered audio according to the timbre instruction information, wherein the timbre instruction information comprises the timbre adding instruction information and/or the timbre modifying instruction information.

13. The audio processing apparatus of claim 12, wherein the one or more programs, when executed by the at least one processor, cause the at least one processor to:
generate a timbre instruction information if a user's triggering a timbre function is detected, wherein, the timbre instruction information comprises a timbre adding instruction information and/or timbre modifying instruction information;
send the timbre instruction information to the pickup, the pickup performs timbre processing on the gathered audio according to the timbre instruction information.

14. (canceled)

15. The audio processing method of claim 1, wherein the pickup is configured to send collected data to the controller, the data comprises selection of a function triggered by a demand to play, a real-time audio generated by user's playing, an audio after the secondary processing of an original audio, a result of an audio analysis and determinations, and time and place of a playing, the data is stored in a data storage unit of the controller.

16. The audio processing method of claim 15, wherein the controller comprises a data analysis unit and a data display unit, the data analysis unit is configured to analysis the received data to obtain an analyzed audio status, the data display unit is configured to display the analyzed audio status.

17. The audio processing method of claim 15, wherein an audio is synthesized by superimposing multiple audio tracks, the synthesized audio comprises a media accompaniment sound, a guitar sound, and a guitar sound with effect, the media accompaniment sound is retrieved from the data storage unit of the controller, the guitar sound is the audio gathered by the pickup from a guitar string; the guitar sound with effect is obtained by processing the gathered guitar sound by a timbre processing chip according to the timbre instruction information, the controller stores the guitar sound with effect in the data storage unit, and generates a playback instruction information, the playback instruction information is sent to the pickup from the controller, and the pickup outputs audio according to the playback instruction information.

18. The audio processing method of claim 10, wherein the controller comprises an instruction interaction unit, the instruction interaction unit is configured to select a function in the controller through an interaction by gesture or otherwise as defined by a user, the controller generates an instruction according to the selected function.

19. The audio processing method of claim 18, wherein the controller comprises a data payment unit, when the controller executes a paid item, the data payment unit is configured to pay for the paid item.

20. The audio processing method of claim 10, wherein the gathered audio is a real-time audio, the step of performing timbre processing on the gathered audio according to the timbre instruction information comprises:
performing processing of adding timbre and/or modifying timbre to the real-time audio through a timbre processing chip;
sending the real-time audio after adding timbre processing and/or change timbre processing to a speaker, the speaker outputs the modified real-time audio.
